(19) United States
(12) Patent Application Publication
(10) Pub. No.: US 2023/0322519 A1
(43) Pub. Date: Oct. 12, 2023

(54) WIRE CONTAINER

(71) Applicant: SIDERGAS SpA, S.Ambrogio di Valpolicella (IT)

(72) Inventor: Carlo GELMETTI, S.Ambrogio di Valpolicella (IT)

(21) Appl. No.: 17/719,266

(22) Filed: Apr. 12, 2022

(51) Int. Cl. B65H 49/08; B23K 9/32

(52) U.S. Cl. CPC B65H 49/08; B23K 9/327

(57) ABSTRACT

A wire container has a bottom plate, a top plate, and a plurality of separate, vertically extending posts. The posts are releasably connected to both the bottom plate and the top plate so as to define a cylindrical receiving space for the wire.

The invention relates to a wire container which is being used to store and transport a length of wire, in particular welding wire, and to make the wire available at a site where it is being consumed.

### BACKGROUND OF THE INVENTION

Wire consumables are employed in many industrial applications: from surface treatments like metallization to joining of metal parts through welding processes.

In many industrial applications, which are nowadays seeing important investments in automatic and robotic systems, a maximized productivity is essential and bulk containers with large quantities of consumable are preferred over smaller spools because they allow to reduce the interruptions and minimize the spool replacement downtime.

A parameter commonly accepted in the welding industry to measure the changeover downtime teaches that it normally takes an average of 15 minutes to replace an empty 15 kg spool with a full new one, and the spool changeover downtime can be therefore quantified in one minute lost to changeover for one kg of wire. Based on this calculation, it appears obvious that a large pack or drum containing 1200 Kgs of product is equivalent to as much as 20 hours of changeover downtime saving. These 20 hours can be better used to actively produce instead of having to continuously interrupt the production because of spool changes: this advantage translates into a significant reduction of production costs and improves the efficiency of the manufacturing processes. It must be added that every undesired production stop can lead to additional complications and disadvantages in terms of consistency of quality, because in certain welding processes like the production of fuel tanks or long welds on trailers or railway cars, it is generally not acceptable to stop in the middle of a weld bead, which must instead preferably be uninterrupted from start-to-end of the welding process; in certain metallization or welding applications, an intermediate unwanted interruption can cause a total rejection and scrapping of the processed part altogether.

Bulk packs containing a large quantity of wire, which allow to produce continuously without interruptions, represent an essential requirement of highly productive robotic and automatic setups. In order to prevent unwanted entanglement of wire loops during transport and handling of the container, the container has to be strong and sturdy enough to keep the coil of wire undeformed and its wire strands exactly where a winding machine has placed them when filling the container.

EP 3 100 818 A1 shows a container for welding wire which comprises a welded wire cage for defining a wire receiving space. The welding wire cage has a high rigidity and allows storing a significant amount of wire within the container. Once all the wire has been consumed, the customer has the problem of discarding the empty container.

The object of the invention is to provide a container which is designed to carry large quantities of wire and engineered to withstand abuse in transport and handling without deformation and whose components, after it has been emptied of its content, can be easily separated and recycled.

### BRIEF DESCRIPTION OF THE INVENTION

The invention provides a wire container having a bottom plate, a top plate, and a plurality of separate, vertically extending posts, the posts being releasably connected to both the bottom plate and the top plate so as to define a cylindrical receiving space for the wire. The posts provide a reliable support for the wire received in the receiving space while they can be very easily detached from the top plate and the bottom plate after the entire wire has been withdrawn from the container. After being disassembled, the individual components of the container can be recycled or otherwise reused.

Underneath the bottom plate, a pallet can be provided to which the bottom plate is connected. Forming a “base part” of the container from two elements, namely the bottom and the pallet, allows adapting each of these components to its particular function. The bottom plate preferably is a plane, closed elements so that there is an even support surface for the wire. The pallet provides stability for the container for being transported, for example with a forklift.

The posts preferably have a circular cross section. They can preferably be made from metal tubes so that there are low manufacturing costs.

For connecting the posts to the bottom plate and/or to the top plate, receiving openings can be provided in the bottom plate and/or the top plate. This allows to very quickly assemble and disassemble the container.

Preferably, eight vertical posts are provided which are arranged at the same radius from a central axis of the container and in equal intervals from each other. It has been found out that as few as eight posts are sufficient to reliably support the wire within the container even if significant vibrations occur during transport of the container.

According to an embodiment of the invention, both the bottom plate and the top plate have a square outer contour, with four corner reinforcements being provided for connecting one of the corner portions of the bottom plate to the respective corner portion of the top plate. The corner reinforcements provide stability for an outer packaging of the wire container, for example made from cardboard.

Also the corner reinforcements can be connected to the bottom plate and/or the top plate by inserting them into receiving openings provided in the bottom plate and/or the top plate. This provides for simple assembly and disassembly of the container.

The top plate and/or the bottom plate can be made from plywood, wood, compressed wood, cardboard, honeycomb cardboard, or plastic. These materials have a sufficiently high strength at a comparable low weight. Further, it is very easy to provide in these materials the receiving openings for receiving the posts.

Preferably, the top plate has a circular center opening, the diameter of which is more than 90% of the diameter of the cylindrical receiving space. The large diameter allows easy access to the wire in the receiving space while at the same time ensuring that the top plate has sufficient rigidity for supporting the posts.

Preferably, four cardboard segments are provided which form an exterior wall of the container. The cardboard segments can be provided in the form of one long sheet which extends circumferentially around the container. The cardboard segments can be attached to the bottom plate and the top plate by means of staples which help in easily manufacturing the wire container.

A plastic bag can be provided within the posts and on top of the bottom plate so that the wire received within the receiving space is protected from humidity.

A retainer can be provided which mechanically engages between the posts so as to extend radially beyond the diameter defined by the posts. The retainer prevents unintentional entanglement of the individual strands of the wire and ensures that the wire can be withdrawn from the container. In an alternative embodiment, the retainer can be formed from a plurality of wire elements connected to each other.

The above object is also achieved with a wire container having a pallet, a square bottom plate connected to the pallet, a square top plate, and eight posts with circular cross section made from metal tubes, the posts being releasably connected to both the bottom plate and the top plate so as to define a cylindrical receiving space for wire, the wire container further having four corner reinforcements arranged so as to extend from one of the corner portions of the bottom plate to an associated one of the corner portions of the top plate, and having four cardboard segments forming the outer walls of the wire container and being attached to both the bottom plate and the top plate. This container is advantageous both regarding the small effort which is necessary for manufacturing it, and the high stability which is provided for wire received therein.

### BRIEF DESCRIPTION OF THE DRAWINGS

FIG. 1 shows a container according to a first embodiment in a side view.

FIG. 2 shows the container of FIG. 1 in a section in plane II-II.

FIG. 3 shows the container of FIG. 1 in a top view.

FIG. 4 shows the container of FIG. 1 in a perspective view.

FIG. 5 shows the container of FIG. 1 in an exploded, perspective view.

FIG. 6 shows the container of FIG. 4 without its outer cardboard segments.

FIG. 7 shows a top view of the container, with the top plate and the vertical posts having been removed.

FIG. 8 shows a cross section in plane VIII-VIII of FIG. 7.

FIG. 9 shows at an enlarged scale the detail IX of FIG. 8.

FIG. 10 shows the container of FIG. 1 in a perspective view, with a retainer being provided in the interior of the container.

FIG. 11 shows a vertical cross section through the container of FIG. 10.

FIG. 12 shows the container of FIG. 10 without the cardboard segments.

FIG. 13 shows the retainer used in the container of FIG. 10 in a top view.

FIG. 14 shows the retainer of FIG. 13 in a side view.

FIG. 15 shows the retainer of FIG. 13 in a perspective view.

FIG. 16 shows a container with a different version of the retainer in a perspective view.

FIG. 17 shows a horizontal cross section through the container of FIG. 16.

FIG. 18 shows the retainer used in the container of FIG. 16 in a top view.

FIG. 19 shows the retainer of FIG. 18 in a side view.

FIG. 20 shows the retainer of FIG. 18 in a perspective view.

FIG. 21 shows a container according to a second embodiment in a perspective view, with the cardboard segments not being shown in order to improve the clarity.

FIG. 22 shows a container according to the second embodiment with a different retainer.

### DETAILED DESCRIPTION OF THE INVENTION

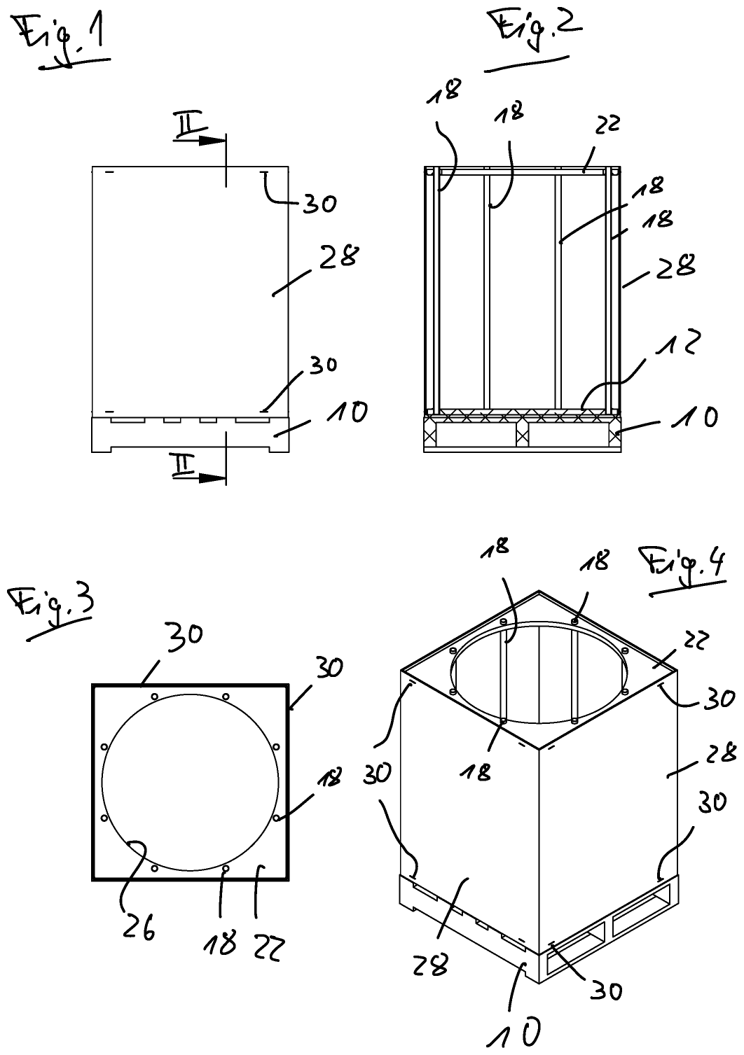

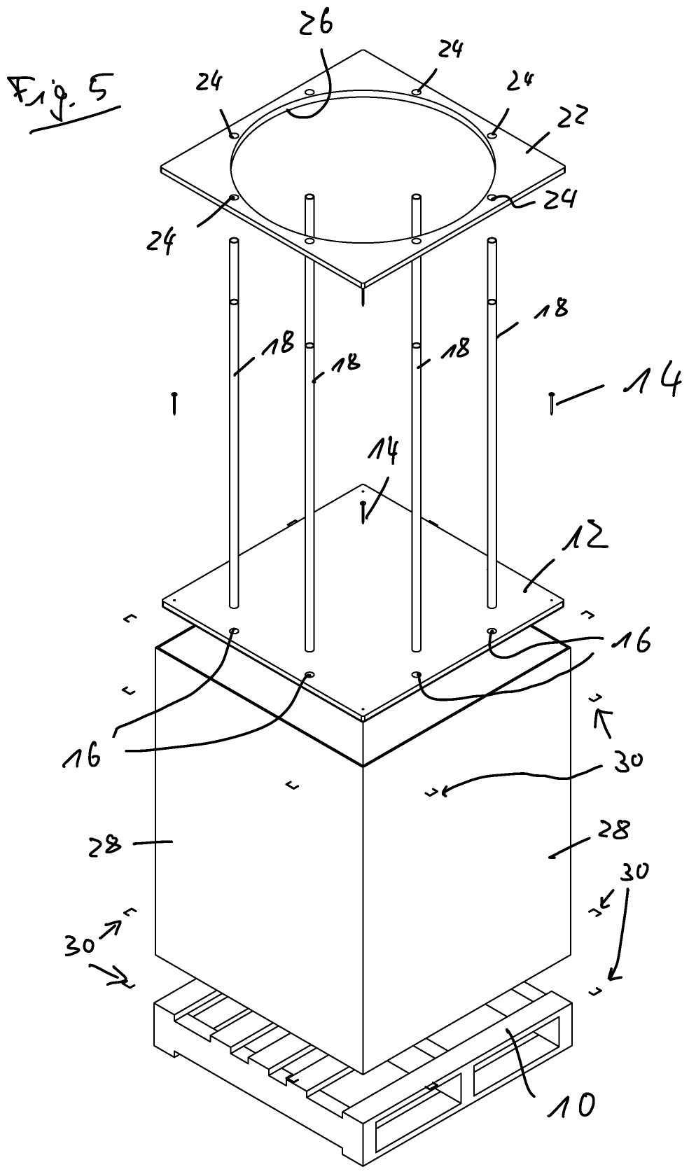

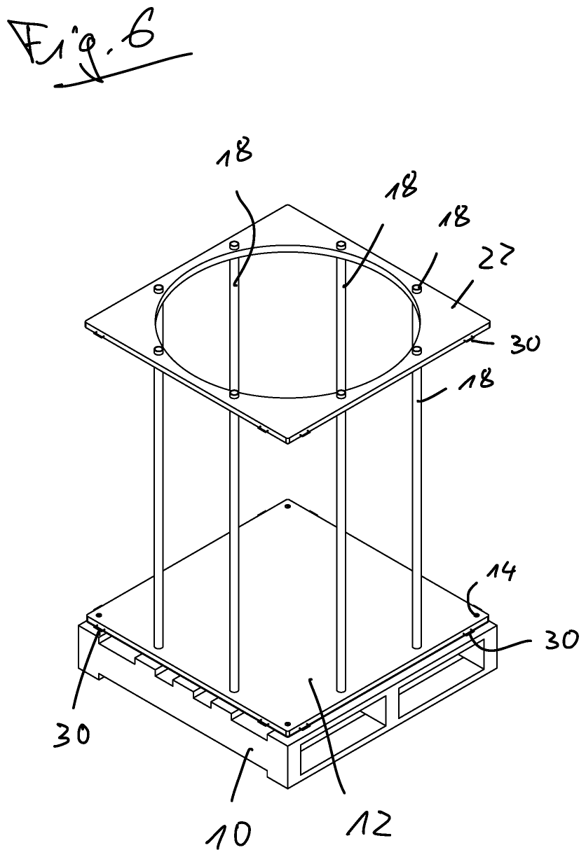

FIGS. 1 to 7 show a first embodiment of a container for receiving wire.

The wire can be welding wire which is received in the form of a coil in the container.

A container comprises a pallet 10 which can be a conventional pallet made of wood.

On top of pallet 10, a bottom plate 12 is arranged. Bottom plate 12 can be made from plywood, wood, compressed wood, cardboard, honeycomb cardboard, or plastic.

Bottom plate 12 has a square shape and a thickness ranging from a few millimeters up to 25 mm.

Bottom plate 12 is connected to pallet 10 by means of suitable attachment means. Here, a couple of nails 14 are used. The nails can be placed adjacent the corners of bottom plate 12.

Bottom plate 12 is provided with a plurality of receiving openings 16 which each receive one of a plurality of vertical posts 18.

Each of posts 18 is here formed from a tube made of metal. It has a diameter in the range of one centimeter to a few centimeters.

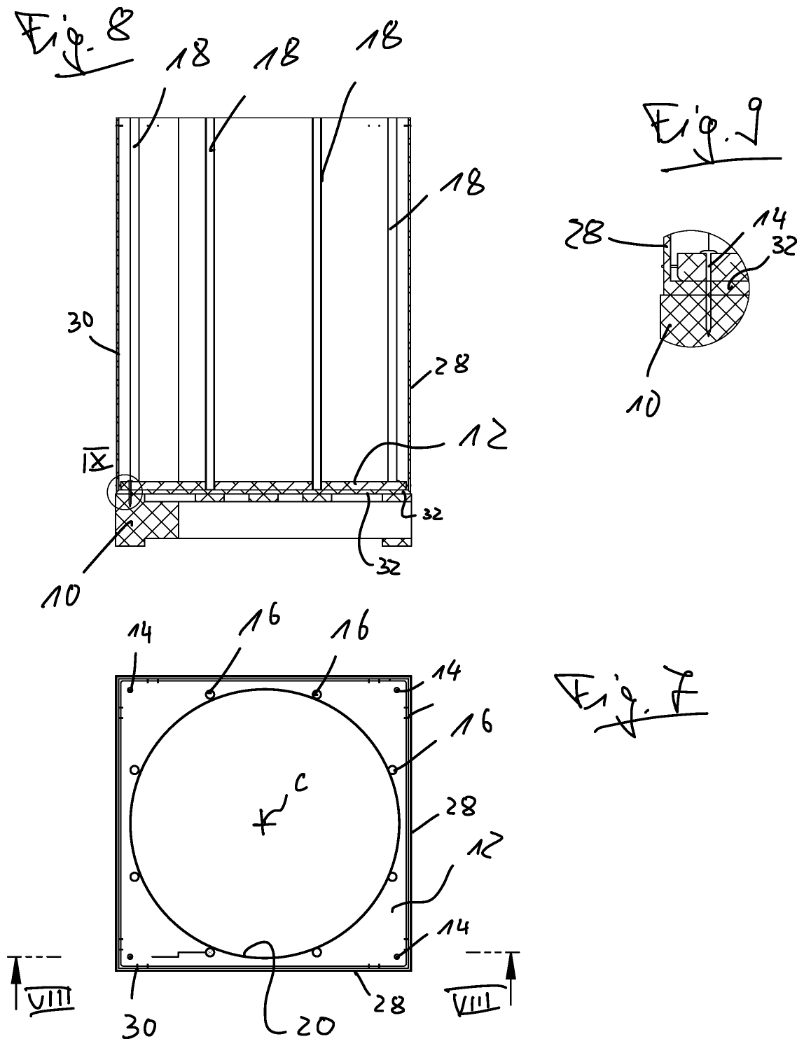

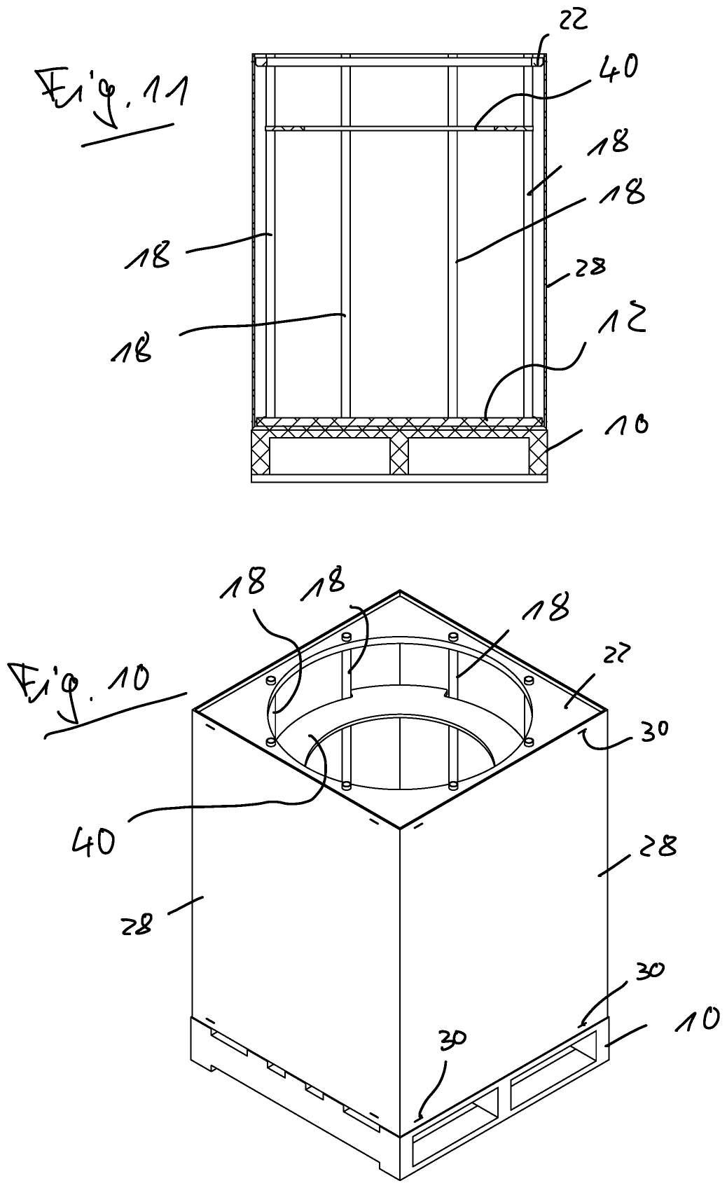

Posts 18 are arranged at the same radius from a center C of the container, and they are in circumferential direction equally spaced from each other. They define a receiving space of which the outer contour is shown in FIG. 7 with reference numeral 20.

The container also comprises a top plate 22 which has receiving openings 24 for posts 18 in the same configuration as the bottom plate 12 has receiving openings 16 for posts 18.

As can be seen in FIGS. 2, 4 and 6, top plate 22 is arranged at a distance from bottom plate 12 such that the upper ends of posts 18 slightly protrude over the upper surface of top plate 22.

Top plate 22 can also be formed from plywood, wood, compressed wood, cardboard, honeycomb cardboard, or plastic. It has the same outer, square contour as bottom plate 12. However, top plate 22 has a circular center opening (the inner circumference of which is designated with reference numeral 26 in the drawings), which provides for access to the receiving space within the container.

The container further comprises four cardboard segments 28 which form the outer sidewalls of the container. Cardboard segments 28 are connected to bottom plate 12 and top plate 22 by means of a plurality of staples 30.

Cardboard segments 28 can be integrally connected to a floor 32 also made from cardboard.

For assembling the container, cardboard segments 28 together with floor 32 are placed on pallet 10. Then, bottom plate 12 is placed in the interior of the space defined by cardboard segments 28, and is connected to pallet 10 with nails 14.

Staples 30 are used for connecting segments 28 to bottom plate 12.

As a next step, posts 18 are inserted into receiving openings 16 of bottom plate 12. Then, top plate 22 is placed within the space defined by cardboard segments 28 so that the upper ends of posts 18 slightly extend beyond the upper surface of top plate 22. When top plate 22 is placed at the desired height, it is fixed with staples 30 to cardboard segments 28.

Posts 18 define the receiving space for the wire in a radial direction. In a vertical direction, the receiving space is limited by bottom plate 12 and top plate 22, while in practice not the entire height of the receiving space will be used for wire.

The pressure which the wire exerts in a radial direction on posts 18 is supported by bottom plate 12 and top plate 22. These prevent posts 18 from being pushed apart.

A rotation or transverse displacement of top plate 22 with respect to bottom plate 12 is prevented by the stability of cardboard segments 28.

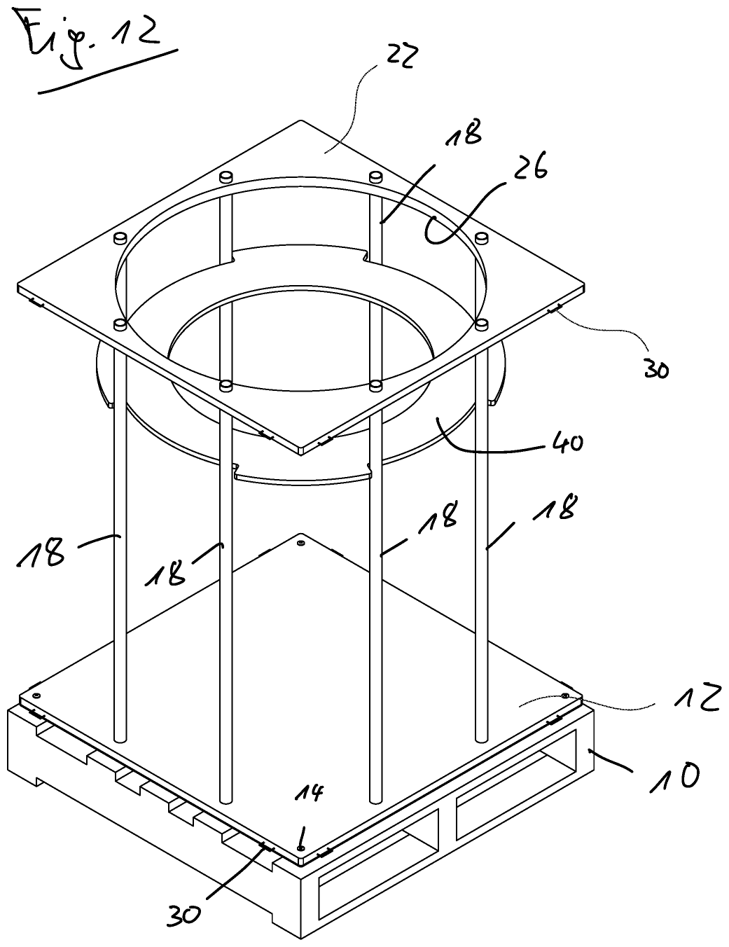

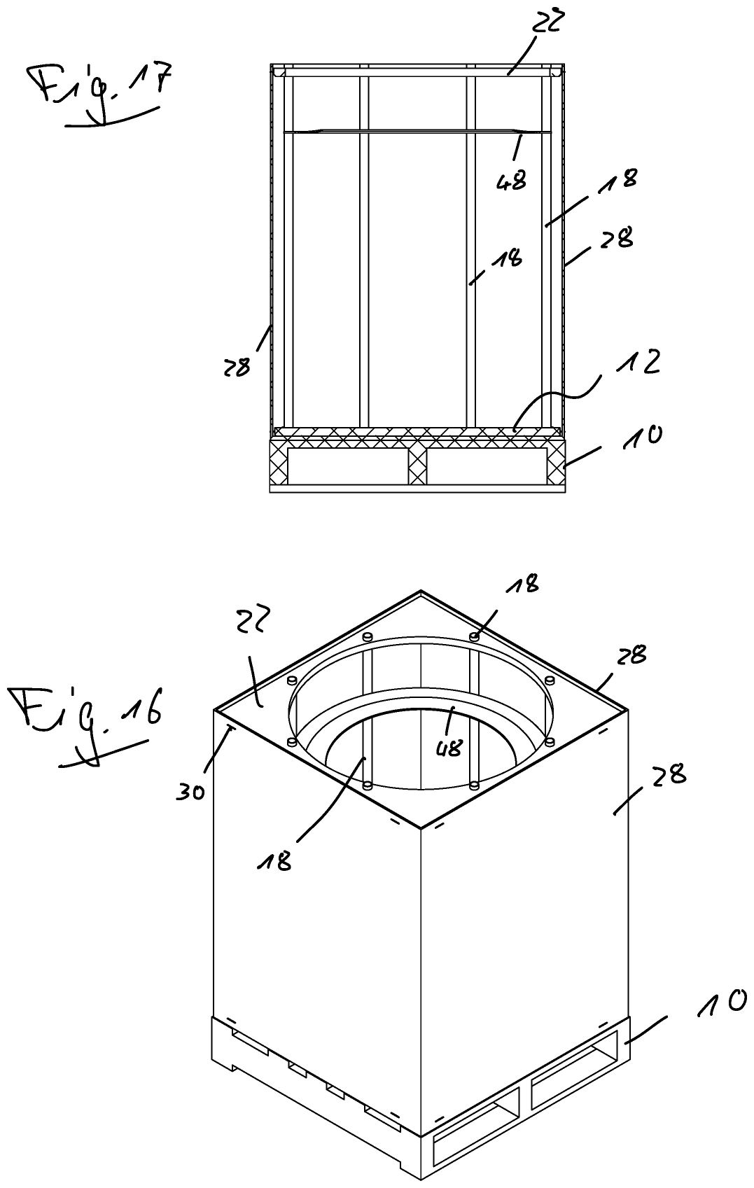

On top of a wire coil received within the container, a retainer can be placed in order to prevent unintended entanglement of the windings of the wire and for facilitating smooth withdrawal of the wire from the container. An embodiment of such retainer is shown in FIGS. 10 to 15.

Retainer 40 here has an annular shape with a central opening delimited by the inner circumference 42 of retainer 40.

The outer circumference of retainer 40 consists of portions 44 which define a diameter which corresponds to the diameter of receiving space 20. Further, larger diameter portions 46 are present at the outer circumference of retainer 40. Larger diameter portions 46 form protrusions which in a mounted condition extend between adjacent posts 18 (please see in particular FIG. 12).

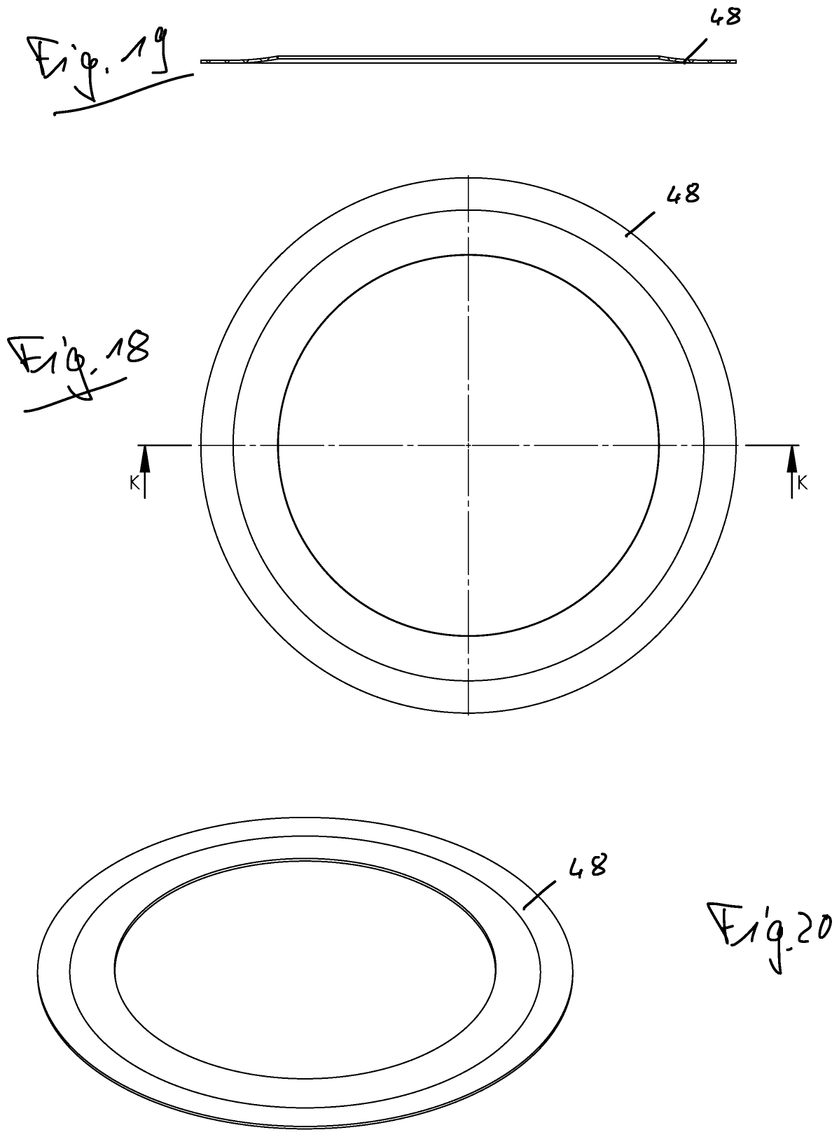

A retainer 48 according to a second variant is shown in FIGS. 16 to 20.

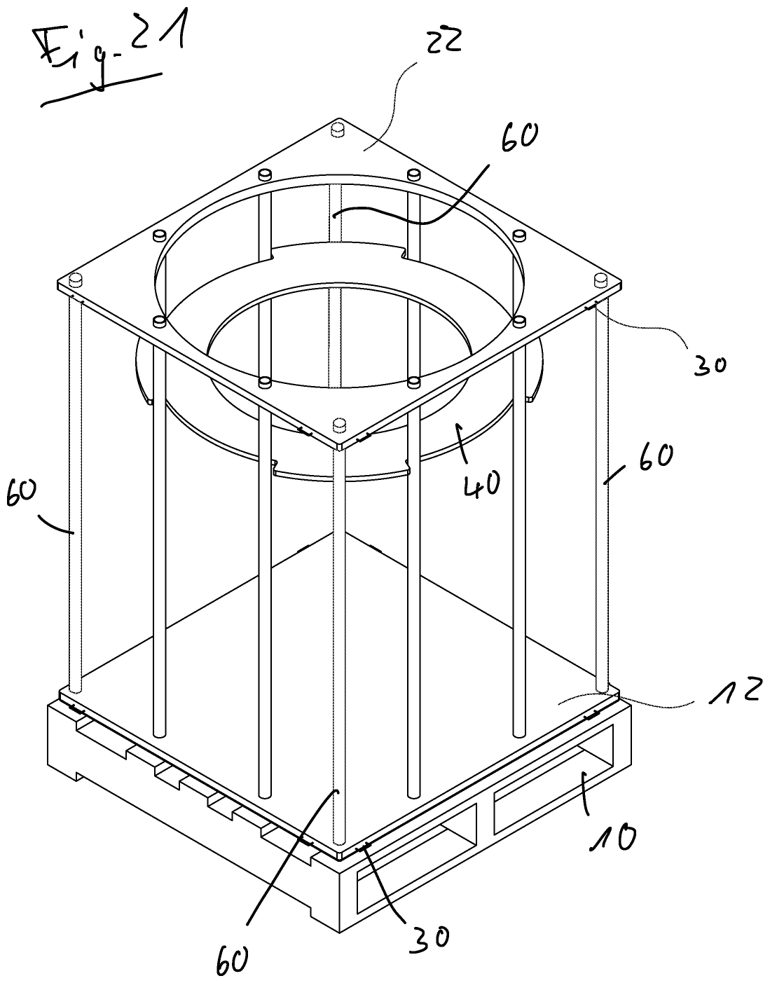

Retainer 48 is formed as an annular ring which is slightly truncated (please see FIG. 19). The outer diameter of retainer 48 corresponds to the diameter of receiving space 20.

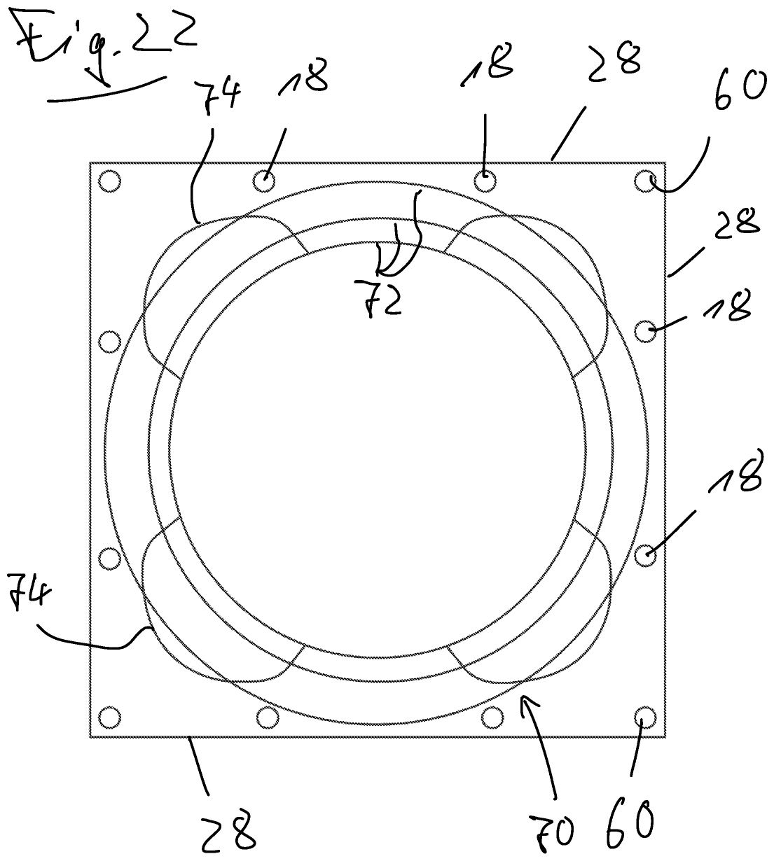

A second embodiment of the container is shown in FIG. 21.

The second embodiment corresponds largely to the first embodiment, with the difference being that four corner reinforcements 60 are provided which are connected to bottom plate 12 and top plate 22 in the same manner as posts 18. Corner reinforcements 60 provide additional stability for cardboard segments 28 adjacent to the corners of bottom plate 12 and top plate 22.

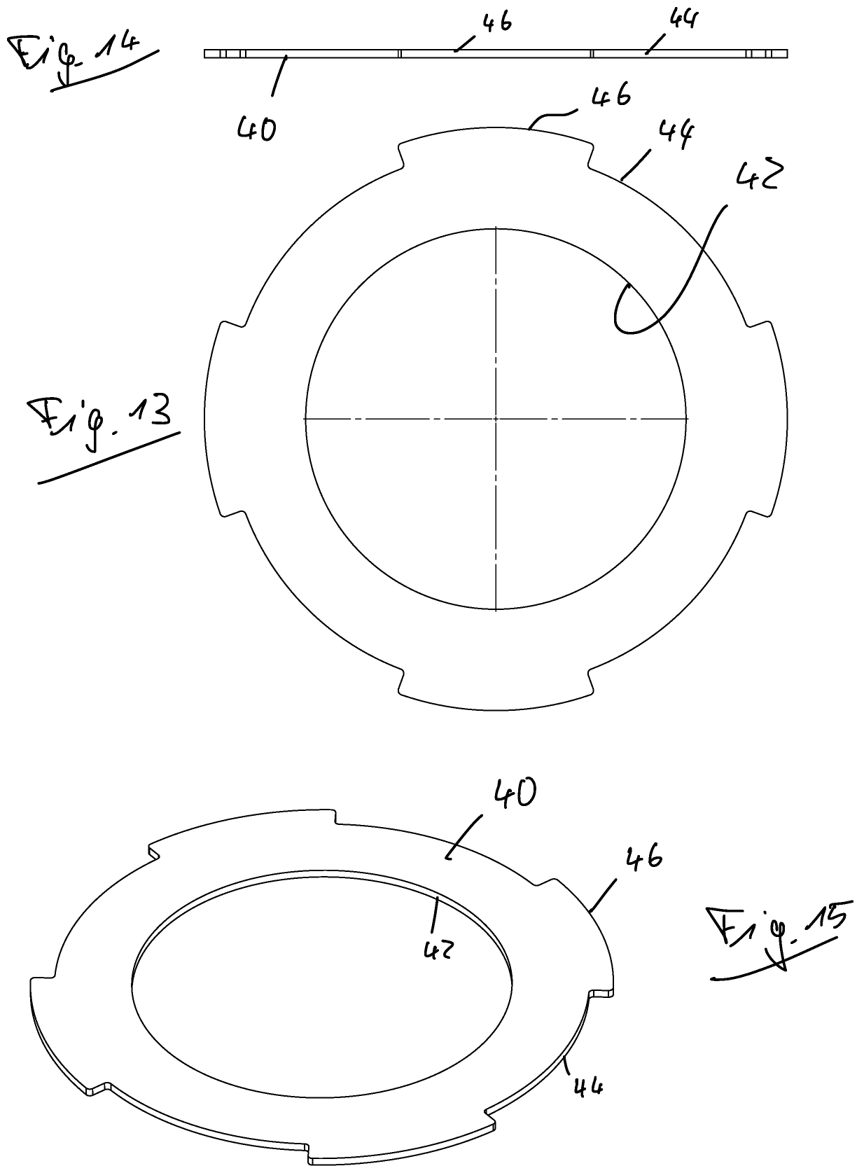

The retainer corresponds to the one shown in FIGS. 13 to 15.

In FIG. 22, a container according to the second embodiment is shown, with a different retainer 70 being used. It consists of three concentric rings 72 formed from wire, which are connected to each other by a plurality of connecting elements 74. These extend beyond the outermost ring and there have the function of the larger diameter portions 46 of the retainer shown in FIGS. 13 to 15.

Connecting elements 74 can be welded or soldered to rings 72.

After the entire wire has been withdrawn from the container, the cardboard segments 28 are removed, and the top plate 22 and the posts 18 can be disassembled without using any tools. Pallet 10 and bottom plate 12 can be recycled or otherwise be disposed.

1. A wire container having a bottom plate, a top plate, and a plurality of separate, vertically extending posts, the posts being releasably connected to both the bottom plate and the top plate so as to define a cylindrical receiving space for the wire.

2. The wire container of claim 1 wherein a pallet is provided underneath the bottom plate, the bottom plate being connected to the pallet.

3. The wire container of claim 1 wherein the posts have a circular cross section.

4. The wire container of claim 1 wherein the posts are made from metal tubes.

5. The wire container of claim 1 wherein the posts are received in receiving openings provided in the bottom plate and/or the top plate.

6. The wire container of claim 1 wherein eight vertical posts are provided which are arranged at the same radius from a central axis of the container and in equal intervals from each other.

7. The wire container of claim 1 wherein both the bottom plate and the top plate have a square outer contour, with four corner reinforcements being provided for connecting one of the corner portions of the bottom plate to the respective corner portion of the top plate.

8. The wire container of claim 7 wherein the corner reinforcements are received in receiving openings in to the bottom plate and/or the top plate.

9. The wire container of claim 1 wherein the top plate and/or the bottom plate is made from one of plywood, wood, compressed wood, cardboard, honeycomb cardboard, and plastic.

10. The wire container of claim 1 wherein the top plate has a circular center opening, the diameter of which is more than 90% of the diameter of the cylindrical receiving space.

11. The wire container of claim 1 wherein four cardboard segments are provided which form an exterior wall of the container.

12. The wire container of claim 11 wherein the cardboard segments are attached at the bottom plate and the top plate by staples.

13. The wire container of claim 1 wherein a plastic bag is provided within the posts and on top of the bottom plate.

14. The wire container of claim 1 wherein a retainer is provided which mechanically engages between the posts so as to extend radially beyond the diameter defined by the posts.

15. The wire container of claim 1 wherein a retainer is provided which is formed from a plurality of wire elements connected to each other.

16. A wire container having a pallet, a square bottom plate connected to the pallet, a square top plate, and eight posts with circular cross section made from metal tubes, the posts being releasably connect to both the bottom plate and the top plate so as to define a cylindrical receiving space for wire, the wire container further having four corner reinforcements arranged so as to extend from one of the corner portions of the bottom plate to an associated one of the corner portions of the top plate, and having four cardboard segments forming the outer walls of the wire container and being attached to both the bottom plate and the top plate.
